(19) United States
(12) Patent Application Publication
(10) Pub. No.: US 2008/0014902 A1
(43) Pub. Date: Jan. 17, 2008

(54) Handheld radio signal tracker

(75) Inventors: Wei-Chieh Liao, Jubei City (TW); Peng-Yuan Hsu, Jubei City (TW)

Correspondence Address: BIRCH STEWART KOLASCH & BIRCH, PO BOX 747, FALLS CHURCH, VA, 22040-0747, US

(73) Assignee: TRANWO TECHNOLOGY CORP.

(21) Appl. No.: 11/485,282

(22) Filed: Jul. 13, 2006

(51) Int. Cl. H04M 11/04

(52) U.S. Cl. 455/404.2

(57) ABSTRACT

A handheld radio signal tracker is provided. The handheld tracker includes a plurality of directional antennas to receive radio signal, whereby a microprocessor will identify the direction and distance of the target which sends the signal. In particular, two directional antennas receive a signal from the same target, the indicating light will show the right direction when the target is positioned in the overlapping area between two directional antennas' detection area.

### BACKGROUND OF THE INVENTION

1. Field of the Invention

The present invention relates to a radio signal tracker, particularly to a handheld radio signal tracker to search the handheld radio signal transmitters.

2. Description of the Prior Art

After the IEEE proposes 802.15 protocols, the proposal standard of WPAN (Wireless Personal Area Network), the standard of next generation of wireless communication is assured. Besides the Bluetooth (802.15.1), the wireless sensor network and the UWB (Ultra Wireless Broadband) will come into the market with their own characteristics, such as speed, price and so on. The wireless sensor network, Bluetooth and UWB will respectively construct their applications at low, medium and high speed on the classification of short-distance wireless communication for themselves.

Because of low power consumption and cost, the wireless sensor network is popular for the home automation from lighting control, curtain control, to water or power meters reading wirelessly, and for medical uses from the medical nursing to the body information collection. The other applications, like air and water inspection, wireless toy, door security, all of these may use wireless sensor network to implement all functions without any wire connection problem.

A conventional wireless tracking system has some transmitters for the children and a sensor for their parent, when the children walking beyond the signal covering area the parent's sensor will alarm, so as the parent won't let the children go too far, some sensor even may show the children's direction or position. There is one conventional wireless tracking system utilizing a unidirectional antenna to detect the direction and distance of a tracked device (transmitter). However, due to the environmental influence, the error is usually too great to tell the correct direction of the tracked device. There is another conventional wireless tracking system utilizing double unidirectional antennas to detect the direction and distance of a tracked device. Although the double directional antennas will detect the direction of the signal, the end-points of two antennas often miss the signal's direction. FIG. 1 shows the missing area A and A′ for the structure of double unidirectional antennas 01 and 02.

### SUMMARY OF THE INVENTION

To realize the direction identification capability of multiple antennas, one embodiment of the present invention provides an handheld radio signal tracker for identifying signal's direction, wherein utilizing the directional antenna to detect the signal from specified area may provide better capability of direction identifying.

To avoid the problem of the dead space occurred in double directional antennas for radio signal tracker, one embodiment of the present invention provides an antenna structure for identifying signal's direction, wherein each directional antenna may receive the wireless signal transmitted from a specified region, and the wireless tracking system using the multiple directional antennas' structure of the present invention may precisely determine the direction and distance of a tracked target.

To achieve the abovementioned objectives, one embodiment of the present invention provides a handheld radio signal tracker, which uses a wireless network to detect at least one handheld radio signal transmitter. The handheld radio signal tracker includes: a first micro-processor executing the programs and computing the data; a wireless transceiver module coupled to the first micro-processor and having at least three directional antennas, the wireless transceiver module receiving a signal using the directional antennas and transforming the signal into digital data, then the digital data being sent to the first micro-processor, wherein the directional antennas are equally assigned detecting sectors for covering a whole 360-degrees zone, and each of the detecting sectors overlaps with the adjacent ones; and a display unit receiving instruction from the first micro-processor for displaying a status of communicating with the handheld radio signal transmitter, and an information of distance and direction.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a conventional antenna structure for identifying signal's direction;

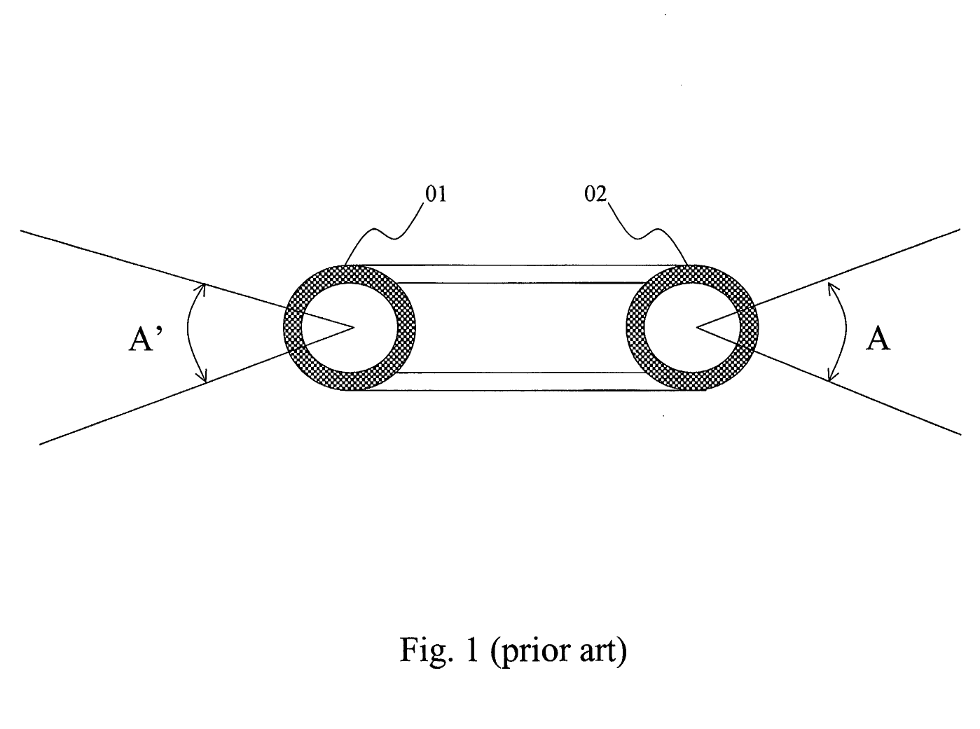

FIG. 2 is a functional diagram of the handheld radio signal tracker according to one embodiment of the present invention;

FIG. 3 is a functional diagram of the handheld radio signal transmitter according to one embodiment of the present invention;

FIG. 4 is the description of the directional antennas' structure for identifying signal's direction according to one embodiment of the present invention; and

FIG. 5 is a display unit of the handheld radio signal tracker for identifying signal's direction according to one embodiment of the present invention.

### DESCRIPTION OF THE PREFERRED EMBODIMENT

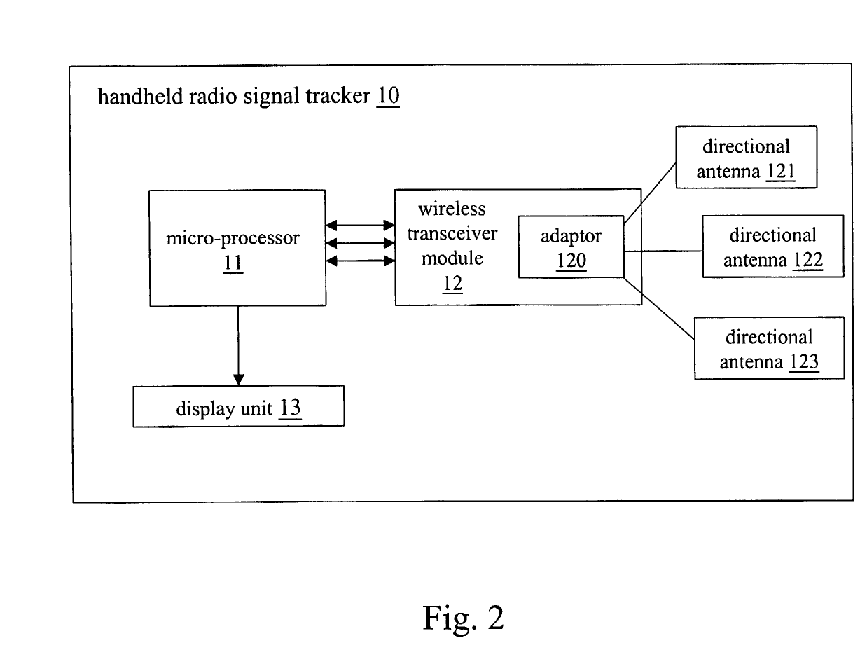

Refer to FIG. 2 for the functional diagram of the handheld radio signal tracker according to one embodiment of the present invention. In this embodiment, the handheld radio signal tracker 10 uses a wireless network to detect at least one handheld radio signal transmitter (not shown), the handheld radio signal tracker 10 includes: a micro-processor 11 executing the programs and computing the data; a wireless transceiver module 12 coupled to the micro-processor 11 and having three directional antennas 121, 122, 123; the adaptor 120 assigning every directional antennas 121, 122, 123 to receive the signals sent from specific detection area; the wireless transceiver 12 module receiving the signals from any directional antennas 121, 122, 123 and transforming the signals into digital data, then the digital data being sent to the micro-processor 11, wherein the directional antennas are equally assigned detection sectors for covering a whole 360-degree zone, and each of the detection sectors overlaps wthe the adjacent ones; and a display unit receiving instruction from the micro-processor 11 for displaying a status of communicating with the handheld radio signal transmitters, and the information of distance and direction thereof.

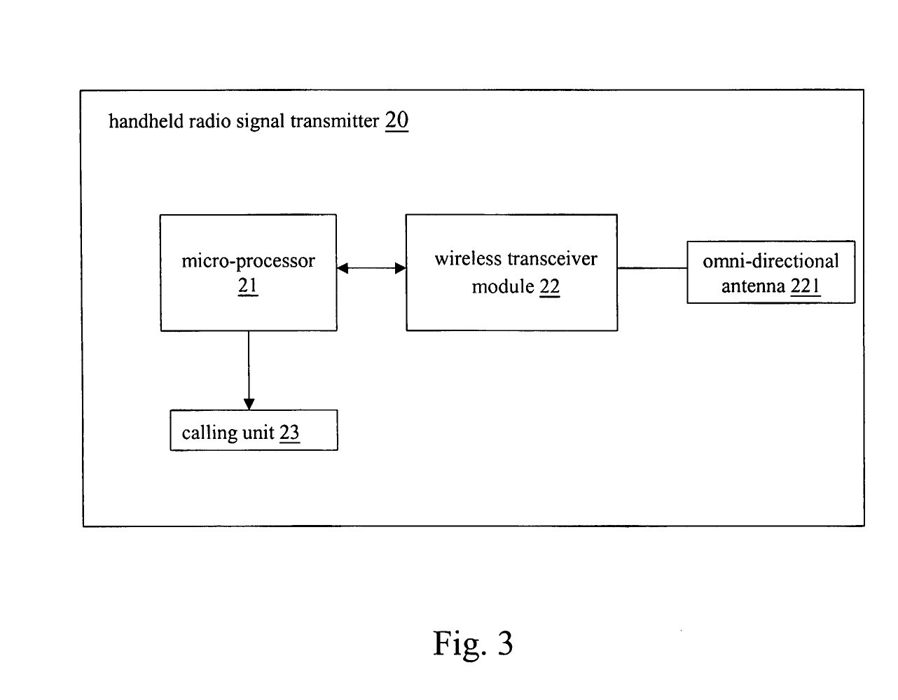

FIG. 3 illustrates the functional diagram of the handheld radio signal transmitter according to one embodiment of the present invention. The handheld radio signal transmitter 20 includes: a micro-processor 21 executing the programs and computing the data; a wireless transceiver module 22 coupled to the micro-processor 21 and having a omni-directional antenna 221, the wireless transceiver module 22 receiving a signal from the omni-directional antenna 221 and transforming the signal into digital data, then the digital data being sent to the micro-processor 21, or the wireless transceiver module 22 receiving the digital data from the micro-processor 21 and transforming the digital data into a signal, then the signal being sent to the omni-directional antenna 221; and a calling unit 23 transmitting an instruction to the micro-processor 21 for enabling the wireless transceiver module 22 to send a specific signal to the air via the omni-directional antenna 221.

Accordingly, the handheld radio signal tracker 10 communicates with the handheld radio signal transmitters 20 via a wireless sensor network, like Zigbee, which assigns every device in the network a unique ID number for conveniently identifying the target device, wherein the device may be the handheld radio signal tracker 10 or the handheld radio signal transmitter 20.

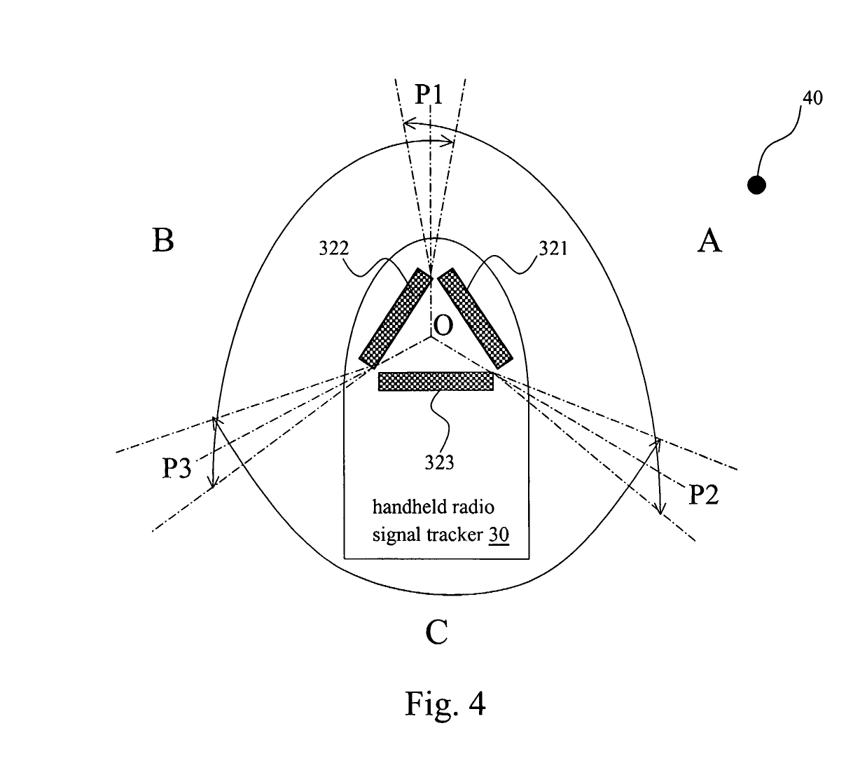

FIG. 4 is the description of the antenna structure for identifying signal's direction according to one embodiment of the present invention. In this embodiment, the antenna structure has three directional antennas 321, 322 and 333 to receive the signals; wherein three directional antennas 321, 322 and 333 are arranged in a triangle shape and the boundaries between those antennas' detecting sectors are OP1, OP2 and OP3, each directional antenna cover 120 degrees. In real implementation, each of directional antennas 321, 322 and 333 covers 140 degrees, thus directional antennas 321, 322 and 333 detect area A, B and C respectively, and each of the overlapping areas is 20-degree sector. When a handheld radio signal transmitter 40 transmits a signal, the directional antenna 321 is controlled by an adaptor to receive the signal, which is then sent to the micro-processor by the wireless transceiver module. The micro-processor processes the signal and output the direction and distance of the handheld radio signal transmitter 40 on the display unit, wherein the display unit is a FPT (Flat Panel Display).

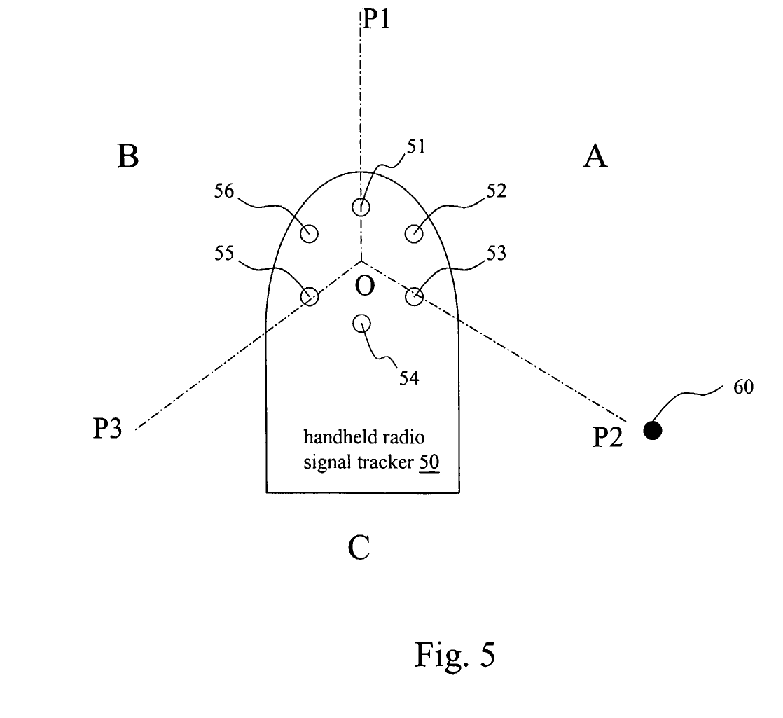

Refer to FIG. 5 for a display unit of the handheld radio signal tracker for identifying signal's direction according to one embodiment of the present invention. In this embodiment, a handheld radio signal tracker 50 utilizes a wireless sensor network to track at least one handheld radio signal transmitter 60. The display unit of the handheld radio signal tracker has six directional lights 51, 52, 53, 54, 55 and 56 to indicate six directions. When a handheld radio signal transmitter 60 positions at the A, B or C sector, the directional light 52, 56 or 54 is on respectively. If the handheld radio signal transmitter 60 positions at the A and C overlapping area the directional light 53 is on. At this event the two directional antennas may receive a same signal, thus the structure of three directional antennas may avoid the dead area to improve the accuracy of detection. In addition, the directional lights 51, 52, 53, 54, 55 and 56 are the LEDs.

Accordingly the handheld radio signal tracker has a “tracking” button, which may send an instruction to the micro-processor. The micro-processor controls the directional antenna that detects the handheld radio signal transmitter to send a signal to that handheld radio signal transmitter for alarming the carrier. In addition, handheld radio signal tracker has some channel indicators to show the direction, distance and status of the handheld radio signal transmitters. Thereby, the handheld radio signal tracker can perform the omni bearing detection of wireless signals and obtain the direction and distance of the tracked device.

The tracked device should have a wireless transceiver module with an antenna to transmit signals to the handheld radio signal tracker 50. The wireless communication network used by the tracked device and the handheld radio signal tracker 50 is a wireless sensor network. In the wireless sensor network, each hardware device should have a unique hardware address so that the hardware device can be recognized in wireless way.

In summary, the present invention utilizes the directional antennas to confine to different sectors respectively. Via allocating different sectors to several antennas, the signal's direction can be identified. The present invention further utilizes the intensity of the received signal to determine the distance between the handheld radio signal tracker and the handheld radio signal transmitters.

Although the Embodiments Abovementioned are described with three directional antennas, some embodiments may use more directional antennas to implement the spirit of the present invention. However, the whole 360 degrees are not necessarily covered by three directional antennas. In the present invention, 360 degrees may also be covered by four directional antennas, and each of them covers a 90-degree sector.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A handheld radio signal tracker using a wireless network to detect at least one handheld radio signal transmitter, comprising:
a first micro-processor executing programs and computing data;
a first wireless transceiver module coupled to said first micro-processor and having at least three directional antennas, said first wireless transceiver module receiving a signal using said directional antennas and transforming said signal into digital data, then said digital data being sent to said first micro-processor, wherein said directional antennas are equally assigned detecting sectors for covering a whole 360-degree zone, and each of said detecting sectors overlaps with the adjacent ones; and
a display unit receiving instruction from said first micro-processor for displaying a status of communicating with said handheld radio signal transmitter, and a information of distance and direction.

2. The handheld radio signal tracker according to claim 1, wherein said wireless network is a wireless sensor network (Zigbee).

3. The handheld radio signal tracker according to claim 1, further comprising an adaptor electrically connected to said directional antennas and controlling each of said directional antennas to receive wireless signals transmitted from a specified sector or to transmit wireless signals to said specified sector.

4. The handheld radio signal tracker according to claim 1, wherein said display unit is a flat panel display.

5. The handheld radio signal tracker according to claim 4, wherein said flat panel display shows said distance, said direction and said status of communicating with said handheld radio signal transmitter.

6. The handheld radio signal tracker according to claim 1, wherein said display unit further comprises an information unit displaying said direction and said distance.

7. The handheld radio signal tracker according to claim 6, wherein said information unit further comprises a plurality of LEDs.

8. The handheld radio signal tracker according to claim 1, wherein said display unit further comprises at least a channel indicator to show said status of said handheld radio signal transmitter.

9. The handheld radio signal tracker according to claim 1, wherein said handheld radio signal transmitter comprises:
a second micro-processor executing programs and computing data; and
a second wireless transceiver module coupled to said second micro-processor and having a omni-directional antenna, said second wireless transceiver module receiving a signal from said omni-directional antenna and transforming said signal into digital data, then said digital data being sent to said second micro-processor, or said second wireless transceiver module receiving the digital data from said second micro-processor and transforming said digital data into a signal, then said signal being sent to said omni-directional antenna.

10. The handheld radio signal tracker according to claim 9, wherein said handheld radio signal transmitter further comprising a calling unit transmitting an instruction to said second micro-processor for enabling said second wireless transceiver module to send a specific signal to the air via said omni-directional antenna.

11. The handheld radio signal tracker according to claim 9, wherein said handheld radio signal tracker receiving a plurality of data from said handheld radio signal transmitter, then calculating said data with an algorithm to output a distance between said handheld radio signal tracker and said handheld radio signal transmitter.
